(19) United States
(12) Patent Application Publication
(10) Pub. No.: US 2007/0029923 A1
(43) Pub. Date: Feb. 8, 2007

(54) Display panel

(76) Inventors: Atsushi Kazama, Moka (JP); Tatsuya Nagata, Ishioka (JP); Takaaki Kitada, Oamishirasato (JP); Takashi Naitou, Mito (JP); Yuichi Sawai, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/497,337

(22) Filed: Aug. 2, 2006

(30) Foreign Application Priority Data
Aug. 2, 2005 (JP) 2005-223533

(51) Int. Cl. H01J 63/04; H01J 1/62

(52) U.S. Cl. 313/496

(57) ABSTRACT

A display panel excellent in reduction in weight and excellent in reliability is provided. The display panel of the invention includes a cover member having a peripheral part bonded and secured to a back surface of a cathode panel, and a central part enclosed by the peripheral part which central part is joined to a reinforcing panel. The reinforcing panel is pressed against a peripheral part of the cathode panel via a support frame by atmospheric pressure exerted on the cover member.

### BACKGROUND OF THE INVENTION

1. Field of the Invention

The present invention relates to a display panel, and more particularly to an art effective when applied to a field emission display (FED: Field Emission Display) panel.

2. Description of Related Art

A field emission display panel has the structure in which a cathode panel with a number of electron sources for emitting electrons formed thereon is disposed so as to be opposed to an anode panel coated with a phosphor via a gap, so that the electrons emitted from the electron source corresponding to each pixel hits against the phosphor to emit light to display an image.

The basic structure of a field emission display panel is described in “Feature article: Basic Knowledge of Electronic Display for Young Engineers” on pages 94-102 of “Electronic Material” published in April, 2004 by Kogyo Chosakai Publishing Co., LTD, (hereinafter referred to as Non-patent Document 1), for example.

Further, as a known document relating to the present invention, there are JP-A-10-188857 and JP-A-2000-2311892, for example.

JP-A-10-188857 discloses an art that “In a flat panel, by adopting a construction in which a reinforcing plate for keeping atmospheric pressure strength is integrated with a back surface of a thin plate panel, it becomes unnecessary to use a glass plate or the like which is too thick as a panel, which makes it possible to achieve reduction in weight, and further it becomes unnecessary to provide a spacer in an effective screen region, which makes it possible to realize high definition”.

JP-A-2000-231892 discloses an art that “By constructing an image display apparatus to include a face panel, a phosphor screen formed on an inner surface of the face panel, a rear envelope provided to be opposed to the face panel to form a vacuum envelope together with the face panel, a substrate disposed inside the vacuum envelope, and a plurality of electron emitting elements formed on a surface on the substrate opposed to the above described phosphor screen, high resolution can be achieved as compared with a cathode ray tube or the like used as a television and a computer display at present. Further, since the panel and the rear envelope are the same as an art used in the conventional cathode-ray tube, press forming can be easily performed while strength against atmospheric pressure can be ensured, and thus a support member is unnecessary, which makes it possible to manufacture it at low cost”.

In additions, JP-A-2000-231892 also discloses an art that “The rear envelope 4 is formed of a nickel alloy of which thermal expansion coefficient substantially corresponds to that of glass, and the rib 13 is provided at an outer surface for increasing strength against atmospheric pressure, whereby the vacuum envelope 5 can be made thinner, and lighter” in paragraph 0019 thereof.

### BRIEF SUMMARY OF THE INVENTION

In a field emission display panel, it is necessary to ensure a gap between electron sources of a cathode panel and phosphors of an anode panel, and to seal there in a vacuum state. In many cases, by providing a number of spacers between the anode panel and the cathode panel, the gap is prevented from being crushed by atmospheric pressure. However, since there are problems that it is difficult to manufacture, dispose, and assemble a spacer which is thin enough to be invisible from the outside, and that the spacer is charged up to become the cause of disturbing an image, a display panel structure without a spacer or with fewer spacers is desired.

In order to realize a spacer-less display panel, it is necessary to prevent the gap from being crushed by the atmospheric pressure. Breakage of the gap can be prevented by increasing the thickness of the anode panel and the cathode panel, and decreasing deflection with respect to the atmospheric pressure. However, in a large screen panel exceeding 32 inches for example, the display panel itself becomes very heavy.

Thus, as a method for reducing the weight of the display panel, reinforcement by a metal material higher in mechanical strength than glass is effective. Since the anode panel is a display surface, it needs to be transparent, and to be glass. On the other hand, since the cathode panel is an invisible part when manufactured as a product, it can be reinforced by a metal member or the like. Further, since a production process of the electron sources is delicate, it is necessary to use a glass substrate with high flatness for the cathode panel. Accordingly, for reduction in weight of the display panel, reinforcement of the back surface side of the cathode panel with a metal member is effective.

However, since it is necessary to heat the panel to a high temperature (for example, about 350° C.) for the reason of removal of water adsorbed to the substrate at a time of evacuation (exhaust) of the inside of the panel, the problem that thermal expansion difference occurs between the glass substrate and the metal reinforcement to cause breakage easily occurs. This affects reliability of the display panel, and therefore, countermeasures are required.

It is an object of the present invention to provide a display panel excellent in reduction in weight and excellent in reliability.

The above described object, other objects and novel features of the present invention will become apparent from the description of the specification and accompanying drawings.

A summary of a typical aspect of the invention disclosed in the present application is briefly explained as follows.

A display panel including:

a cathode panel having a main surface, a back surface on an opposite side to the main surface, and an electron source provided on the main surface;

an anode panel having a phosphor, which panel is bonded and secured to the main surface of the above described cathode panel so that the phosphor and the electron source are spaced from and opposed to each other;

a first cavity formed by the above described cathode panel and the above described anode panel, in which cavity the phosphor and the electron source are located;

a cover member having a peripheral part and a central part enclosed by the peripheral part, the peripheral part being bonded and secured to the back surface of the above described cathode panel, the central part being spaced from the back surface of the above described cathode panel;

a second cavity formed by the above described cathode panel and the above described cover member;

a reinforcing panel having a peripheral part and a central part enclosed by the peripheral part, the central part being joined to the central part of the above described cover member; and

a support frame interposed between the peripheral part of the above described cover member and the peripheral part of the above described reinforcing panel, wherein

the insides of the above described first and second cavities are depressurized more than the outside, and

the above described reinforcing panel is pressed against the above described cathode panel via the above described support frame by atmospheric pressure exerted on the above described cover member.

An effect obtained by the typical aspect of the invention disclosed in the present application is briefly explained as follows.

According to the present invention, a display panel excellent in reduction in thickness and excellent in reliability is provided.

### BRIEF DESCRIPTION OF THE SEVERAL VIEWS OF THE DRAWINGS

FIG. 1 is a schematic perspective view showing an external structure of a display apparatus into which a display panel of one embodiment of the present invention is incorporated;

FIG. 2 is a schematic plane view showing the external structure of the display panel of one embodiment of the present invention;

FIG. 3A is a view showing an internal structure of the display panel of one embodiment of the present invention, and is a schematic sectional view taken along the line a-a in FIG. 2;

FIG. 3B is a view showing the internal structure of the display panel of one embodiment of the present invention, and is a schematic sectional view taken along the line b-b in FIG. 2; and

FIG. 4 is a developed view of FIGS. 3A and 3B.

### DETAILED DESCRIPTION OF THE INVENTION

An embodiment of the present invention will now be described in detail with reference to the drawings. In all of the drawings for explaining the embodiment of the present invention, components having the same functions are assigned with the same reference numerals and characters, and thus the redundant explanation thereof will be omitted.

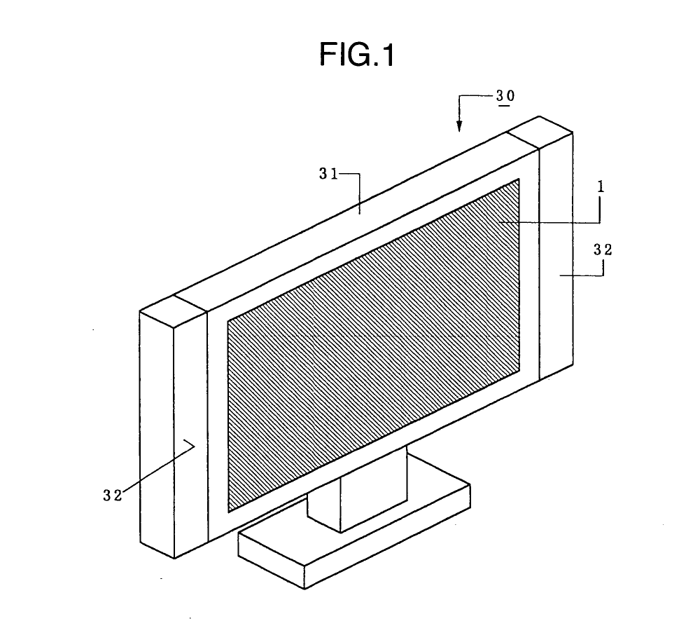

FIGS. 1 to 4 are views according to a display panel of one embodiment of the present invention,

FIG. 1 is a schematic perspective view showing an external structure of a display apparatus into which the display panel is incorporated,

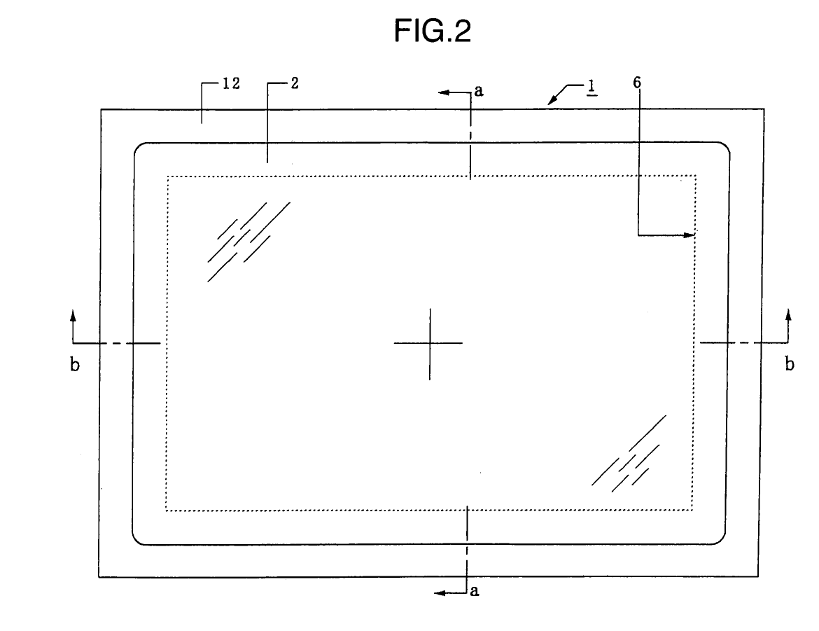

FIG. 2 is a schematic plane view showing the external structure of the display panel,

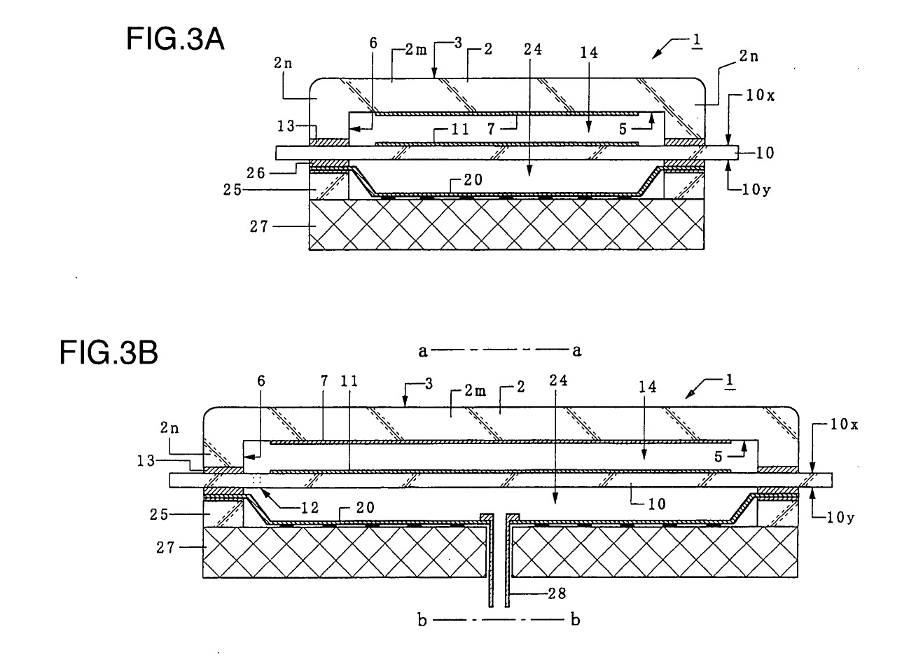

FIGS. 3A and 3B are views showing an internal structure of the display panel (FIG. 3A is a schematic sectional view taken along the line a-a in FIG. 2, and FIG. 3B is a schematic sectional view taken long the line b-b in FIG. 2), and

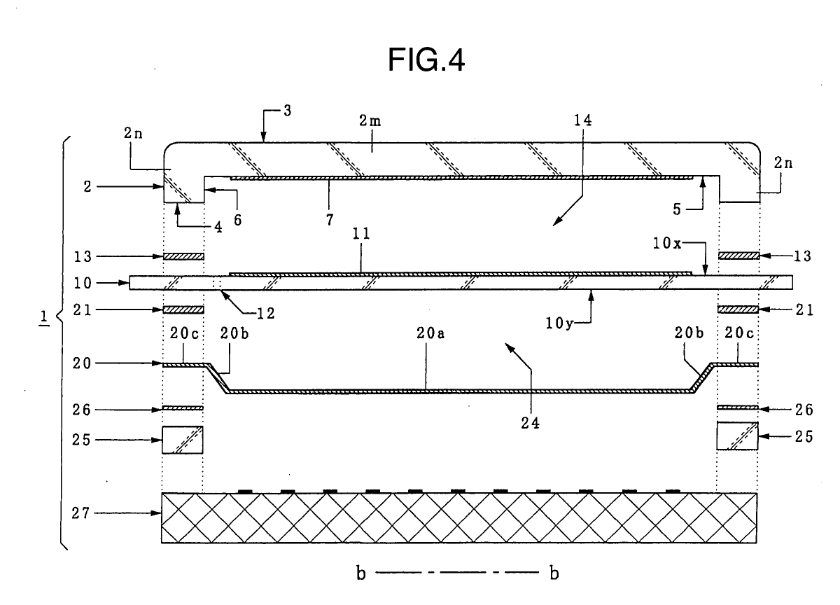

FIG. 4 is a developed view of FIGS. 3A and 3B.

In FIG. 4, in order to make the drawing easy to see, illustration of a portion of an exhaust pipe in FIGS. 3A and 3B is omitted. Further, in FIGS. 3A, 3B and 4, wiring formed on a cathode panel is omitted.

A display apparatus 30 shown in FIG. 1 is an example applied to a television set, and has a construction having a casing 31, a display panel 1, a speaker 32 and the like. The display panel 1 of the present invention is applicable as a display apparatus of a personal computer, a DVD or the like other than a television set.

The display panel 1 is thin and light, and is mounted inside the casing 31, and an anode panel of the display panel 1 is exposed in a planar shape from a full surface window of the casing 31.

In connection with reduction in thickness of the display panel 1, the casing 31 is also formed to be thin. Inside the casing 31, a power supply, a television tuner, a control unit and the like are housed, and are connected to the display panel 1. For example, speakers 32 are mounted on both sides of the casing 31.

Next, the display panel 1 will be described by using FIGS. 2 to 4.

As shown in FIG. 2, the display panel 1 has a flat surface of a square shape, and is, in this embodiment, rectangular for example. As shown in FIGS. 3A, 3B and 4, the display panel 1 has the construction mainly having an anode panel 2, a phosphor 7, a cathode panel 10, an electron source 11, a cover member 20, a support frame 25, a reinforcing panel 27 and the like, and further having a cavity (vacuum chamber) 14 formed by the anode panel 2 and the cathode panel 10, and a cavity (vacuum chamber) 24 formed by the cathode panel 10 and the cover member 20.

The phosphor 7 is provided on the anode panel 2, and the electron source 11 is provided on a main surface 10x of the cathode panel 10. The anode panel 2 is bonded and secured to the main surface 10x of the cathode panel 10 so that the phosphor 7 and the electron source 11 are spaced from each other and opposed to each other. The phosphor 7 and the electron source 11 are disposed in the cavity 14 in a state where those are spaced from each other and opposed to each other. The inside of the cavity 14 is depressurized in comparison with the outside, and is not under absolute vacuum but in a substantially vacuum state. The display panel 1 of this embodiment is designed such that electrons emitted from the electron source 11 hit against the phosphor 7, and thereby the phosphor 7 emits light to display an image. A display surface of the display panel 1 is formed by the anode panel 2.

The electron source 11 is illustrated such that the disposition regions of the electron sources are integrated for the purpose of omission of illustration in FIGS. 3A, 3B and 4. However, in practice, a number of electron sources are arranged two-dimensionally. In addition, the phosphor 7 is illustrated such that the disposition regions of the phosphors are integrated for the purpose of omission of illustration in FIGS. 3A, 3B and 4, however, in the case of a color panel for example, red, green and blue phosphors are two-dimensionally arranged to correspond to the electron sources.

In the anode panel 2 and the cathode panel 10, the flat surfaces thereof are formed in a square shape, and are, in this embodiment, rectangular as shown in FIG. 2 for example. The cathode panel 10 has a larger plane size than that of the anode panel 2.

The anode panel 2 is formed of transparent glass. The anode panel 2 of this embodiment is not limited to this, but, for example, as shown in FIG. 4, has the construction having a first surface (display surface) 3, a second surface (seal surface) 4 on an opposite to the first surface 3, a recessed part 6 which is recessed toward the first surface 3 side from the second surface 4, and has a third surface (phosphor formation surface) 5 at the bottom, and the phosphor 7 provided on the third surface 5. Namely, the anode panel 2 is in a cap shape provided with the recessed part 6 which is recessed to the first surface 3 side from the second surface 4, on the second surface 4 side which is the opposite side to the first surface 3 as a display surface.

The recessed part 6 has a flat surface of a square shape, which is, for example, rectangular in the embodiment 1 (not shown in detail in the drawing). The second surface 4 is formed to surround the recessed part 6. That is, the anode panel 2 has the construction-having a base part (display part) 2m including the first surface 3 and the third surface 5, and a leg part (skirt part) 2n including the second surface 4, and is formed into a frame shape to enclose the third surface 5.

The cathode panel 10 has the main surface 10× and a back surface 10y which are located at the opposite sides to each other, the electron source 11 is provided on the main surface 10x, and wiring not shown is further provided, as shown in FIGS. 3A and 3B. The cathode panel 10 is formed into a planar shape. As a material of the cathode panel 10, for example, glass is used for the reason of easiness in forming the electron source 11 and wiring, conformance to the linear expansion coefficient of the anode panel 2 and the like.

The anode panel 2 and the cathode panel 10 are bonded and secured (fixed) by an adhesive material (sealing material) 13 interposed between the second surface 4 of the anode panel 2 and the main surface 10x of the cathode panel 10. The cavity 14 is hermetically sealed by fixing the anode panel 2 and the cathode panel 10 with the adhesive material 13. As an adhesive material 13, for example, glass frit is used.

The cover member 20 has a peripheral part and a central part enclosed by the peripheral part, with the peripheral part bonded and secured to the back surface 10y of the cathode panel 10, and the central part separated from the back surface 10y of the cathode panel 10. The cover member 20 of this embodiment is constructed into a dish shape having a first portion 20a separated from the back surface 10y of the cathode panel 10, a second portion 20b extending toward the back surface 10y of the cathode panel 10 from the first portion 20a, and a third portion 20c extending along the back surface 10y of the cathode panel 20 to the outside from the second portion 20b, as shown in, for example, FIG. 4. Such a dish shape can be easily formed by applying press work to a planer member.

The cover member 20 and the cathode panel 10 are bonded and secured (fixed) by an adhesive material 21 interposed between the third portions 20c of the cover member 20 and the back surface 10y of the cathode panel 10. The cavity 24 is hermetically sealed by fixing the cover member 20 and the cathode panel 10 with the adhesive material 21. The inside of the cavity 24 is depressurized with respect to the outside, and is not under absolutely vacuum, but in a substantially vacuum state. The cover member 20 is formed of a thin metal plate having flexibility, for example. As a material of the cover member 20, a material with the thermal expansion coefficient close to that of glass is desirable, and for example, an iron nickel alloy, stainless steel (SUS430), and the like are used. As an adhesive material 21, for example, glass frit is used.

In the reinforcing panel 27, the flat surface is formed in a square shape, and is rectangular having an outside size substantially equal to the anode panel 2, for example, in this embodiment. The reinforcing panel 27 has a peripheral part and a central part enclosed by the peripheral part, and the central part is joined to the first portion (central portion) 20a of the cover member 20. Joint of the reinforcing panel 27 and the cover member 20 is performed by, for example, spot welding, brazing or the like.

The support frame 25 is interposed between the third portion 20c of the cover member 20 and the peripheral part of the reinforcing panel 27. The outer shape of the support frame 25 substantially corresponds to the outer shape of the anode panel 2, and the support frame 25 is disposed at a position where it two-dimensionally coincides with the leg part 2n (second surface 4) of the anode panel 2.

The support frame 25 is not bonded and secured to the reinforcing panel 27, but may be or may not be bonded and secured to the cover member 20. In this embodiment, the support frame 25 is bonded and secured to the third portion 20c of the cover member 20 via an adhesive material 26. As a material of the support frame 25, glass, a metal with the thermal expansion coefficient close to that of glass or the like is desirably used. Since the glass is lower in density than a metal, the weight is reduced by using glass.

As shown in FIG. 3B, the cathode panel 10 is provided with a through-hole (vent hole) 12 which connects the cavity 14 on the side of the main surface 10x of the cathode panel 10, and the cavity 24 on the side of the back surface 10y of the cathode panel 10. The through-hole 12 is disposed at a position such that the electron source 11 and the wiring are avoided. An exhaust pipe 28 for evacuation is connected to the cavity 24. The exhaust pipe 28 is closed to keep a vacuum state in the cavities 14 and 24 after evacuation of the cavities 14 and 24.

The insides of the cavities 14 and 24 are depressurized with respect to the outside. Atmospheric pressure is exerted on the cover member 20 by the depressurization, and the cover member 20 is deformed. The cover member 20 has its central portion (first portion 20a) joined to the central part of the reinforcing panel 27, and therefore, by deformation of the cover member 20 (mainly the deformation of the second portion 20b) by atmospheric pressure, a force to draw the reinforcing panel 27 to the cathode panel 10 acts on the reinforcing panel 27. Since the support frame 25 is provided between the cathode panel 10 and the reinforcing panel 27 so as to enclose the first portion 20a and the second portion 20b of the cover member 20, the reinforcing panel 27 is pressed against the cathode panel 10 so as to be supported thereby via the support frame 25 by the force to draw the reinforcing panel 27 to the cathode panel 10. That is, the reinforcing panel 27 is pressed against the cathode panel 10 via the support frame 25 by the atmospheric pressure exerted on the cover member 20 due to evacuation of the inside of the cavity 24.

The cover member 20 is supported by the reinforcing panel 27 via the support frame 25 so that the cover member 20 is not deformed by atmospheric pressure and the cavity 24 does not become crushed.

In manufacturing a field emission display panel, at a time of evacuating (exhausting) the inside of the cavity in which the electron sources and phosphors are disposed, it is necessary to keep the panel at a high temperature (for example, about 350° C.) for the reason of removing water adhering to the panel and the like.

In the display panel 1 of this embodiment, the cover member 20 has the peripheral part (the third portion 20c) bonded and secured to the cathode panel 10, and the central part (20a) separated from the cathode panel 10 is joined to the central part of the reinforcing panel 27. The reinforcing panel 27 is pressed against the cathode panel 10 via the support frame 25 by atmospheric pressure exerted on the cover member 20 due to evacuation in the cavity 24, and further, is not bonded and secured to the cathode panel 10. By adopting such a construction, even when the thermal treatment as described above is applied, the cover member 20 can deform to absorb the thermal expansion difference between the cathode panel 10 and the reinforcing panel 27, and therefore, breakage in the bonding portion of the cathode panel 10 and the cover member 20 can be restrained. Since the thermal expansion difference between the cathode panel 10 and the reinforcing panel 27 can be absorbed, those can be reinforced by using the reinforcing panel 27 formed of a material with a different linear expansion coefficient with respect to the cathode panel 10. As a result, the display panel 1 excellent in reduction in thickness and excellent in reliability can be obtained.

The display panel 1 of this embodiment is provided with the evacuated cavities (14, 24) on the front and back surfaces (the main surface 10x and the back surface 10y) of the cathode panel 10, respectively. By adopting such a construction, deflection of the cathode panel 10 can be suppressed even if the thickness is reduced, and therefore, reduction in weight and thickness of the display panel 1 can be achieved.

The cathode panel 10 is provided with the through-hole 12 which connects (joins) the cavity 14 on the side of the main surface 10x of the cathode panel 10 and the cavity 24 on the side of the back surface 10y of the cathode panel 10. By adopting such a construction, it is possible to collectively depressurize the insides of the both cavities by evacuating the inside of any one of the cavities 14 and 24 through the exhaust pipe. In this embodiment, the exhaust pipe 27 is connected to the cavity 24, and the insides of both the cavities can be evacuated by connecting the exhaust pipe to any one of the cavities. Therefore, as compared with the case where the exhaust pipes are connected to the two cavities respectively, the structure can be simplified, and cost reduction can be achieved.

In the display panel 1 of this embodiment, the bonding portion of the anode panel 2 (the foot part 2n, the second surface 4) and the support frame 25 are disposed at a position where those two-dimensionally coincides with each other. Therefore, the atmospheric pressure exerted on the anode panel 2 and the reinforcing panel 27 are balanced on the front and back surfaces of the cathode panel 10, so that large bending stress does not occur with respect to the cathode panel 10.

Here, the reinforcing panel 27 is desired to be constructed by a structure and a material light in weight and high in bending rigidity so as not to break even when bent by atmospheric pressure. As a structure, for example, by adopting a honey comb structure, a rib structure, a porous body, or a structure with a plurality of cloth fibers stacked in layer, that function can be achieved. As a material, for example, by using stainless steel (SUS430), a steel plate and the like, that function can be achieved.

In this embodiment, the example in which the through-hole 12 in the cathode panel 10 are provided to unite the two cavities (14, 24) is described, but the construction in which the two cavities (14, 24) are independent respectively without providing the through-hole 12 in the cathode panel 10 may be adopted. However, in this case, the exhaust pipes need to be connected to the two cavities (14, 24) respectively, and therefore, the structure is complicated.

On the other hand, from the viewpoint of securing the performance of the electron sources, it is desirable to keep high degree of vacuum in the cavity 14, and the advantage of easily obtaining high degree of vacuum is obtained by making the cavity 14 independent. Thereby, in this case, it is desirable that the cavity 14 is higher in degree of vacuum than the cavity 24.

The exhaust pipe for evacuating the cavity 24 can be mounted by providing notched portions in the cover member 20, the support frame 25 and the reinforcing panel 27, at one portion of the back surface 10y of the cathode panel 10 for example, and by forming a vent hole in the cathode panel 10 by the notched portions.

In this embodiment, the example provided with the support frame 25 is described, but the reinforcing panel 27 may be formed in a cap shape like the anode panel 2. Since the support frame 25 can be omitted in that case, the number of components in the assembly process (manufacture) can be reduced, and manufacturing yield can be enhanced.

In this embodiment, the example in which the support frame 25 is bonded and secured to the third portion 20c of the cover member 20 is described, but the support frame 25 may not bonded and secured. In short, the reinforcing panel 27 just has to be not bonded and secured to the cathode panel 10, and the reinforcing panel 27 has to be in a movable state in a plane direction by the thermal expansion difference from the cathode panel 10.

The invention made by the present inventor has been described thus far based on the above described embodiment, but the present invention is not limited to the above described embodiment, and it goes without saying that various modifications can be made within the scope not to depart from the spirit of the present invention.

1. A display panel, comprising:
a cathode panel having a main surface, a back surface on an opposite side to the main surface, and an electron source provided on the main surface;
an anode panel having a phosphor, which panel is bonded and fixed to the main surface of said cathode panel so that the phosphor and the electron source are spaced from and opposed to each other;
a first cavity formed by said cathode panel and said anode panel, in which cavity the phosphor and the electron source are located;
a cover member having a peripheral part and a central part enclosed by the peripheral part, the peripheral part being bonded and fixed to the back surface of said cathode panel, the central part being spaced from the back surface of said cathode panel;
a second cavity formed by said cathode panel and said cover member;
a reinforcing panel having a peripheral part and a central part enclosed by the peripheral part, the central part being joined to the central part of said cover member; and
a support frame interposed between the peripheral part of said cover member and the peripheral part of said reinforcing panel, wherein
the insides of said first and second cavities are depressurized more than the outside, and
said reinforcing panel is pressed against said cathode panel via said support frame by atmospheric pressure exerted on said cover member.

2. The display panel according to claim 1, wherein said cover member is formed of a thin metal plate having flexibility.

3. The display panel according to claim 1, wherein said cover member comprises: a first portion spaced from the back surface of said cathode panel and joined to said reinforcing panel; a second portion extending from the first portion toward the back surface of said cathode panel; and a third portion extending outward from the second portion along the back surface of said cathode panel, and wherein the third portion is interposed between the back surface of said cathode panel and said support frame, and is bonded and fixed to the back surface of said cathode panel.

4. The display panel according to claim 1, wherein said cathode panel is formed of a plate made of glass.

5. The display panel according to claim 1, wherein said cathode panel is provided with a through-hole which connects said first cavity to said second cavity.

6. The display panel according to claim 1, wherein said anode panel comprises: a first surface which is a display surface; a second surface on an opposite side to the first surface; and a recessed part which is recessed toward a first surface side from the second surface and has a third surface at the bottom, and wherein the phosphor is formed on the third surface.

7. The display panel according to claim 1, wherein said support frame is disposed in a place which two-dimensionally overlaps with a portion where said cathode panel and said anode panel are bonded and fixed.

8. The display panel according to claim 1, wherein said reinforcing panel is a honeycomb structure, a rib structure, a porous body, or a structure in which a plurality of cloth fibers are stacked.
